(19) United States
(12) Patent Application Publication
(10) Pub. No.: US 2014/0167907 A1
(43) Pub. Date: Jun. 19, 2014

(54) TEMPERATURE-DEPENDENT SWITCH

(71) Applicant: Marcel P. HOFSAESS, SONDERSHAUSEN (DE)

(72) Inventor: Marcel P. HOFSAESS, SONDERSHAUSEN (DE)

(21) Appl. No.: 14/098,852

(22) Filed: Dec. 6, 2013

(30) Foreign Application Priority Data
Dec. 13, 2012 (DE) 10 2012 112 207.5

(51) Int. Cl. H01H 37/04; H01H 11/00

(52) U.S. Cl. CPC H01H 37/04; H01H 11/00
USPC 337/298; 29/622

(57) ABSTRACT

A temperature-dependent switch having a housing 2, which has a cover part and a lower part, and having a temperature-dependent switching mechanism, which is arranged in the housing 2 and which, depending on its temperature, produces or opens an electrically conductive connection between two external connection terminals provided on an upper surface 25 of the housing 2, is provided with a shielding housing 41 made of an electrically conductive, metal material, into which the housing 2 is inserted with its bottom side 24 first.

### BACKGROUND OF THE INVENTION

The present invention relates to a temperature-dependent switch comprising a housing, which housing has a cover part as well as a lower part, said lower part comprising a peripheral wall and a bottom side, and a temperature-dependent switching mechanism, which switching mechanism is arranged in the housing and which, depending on its temperature, produces or opens an electrically conductive connection between two external connection terminals provided on the housing.

A switch of this type is known for example from DE 103 01 803 A1.

The known temperature-dependent switch is used in a manner known per se to monitor the temperature of a device. To this end, it is brought into thermal contact with the device to be protected, for example via one of its outer surfaces, such that the temperature of the device to be protected influences the temperature of the switching mechanism.

The switch, via the connection lines soldered to its external connection terminals, is electrically connected in series into the supply circuit of the device to be protected, such that the supply current of the device to be protected flows through the switch when the switch is below its response temperature.

The known switch has a deep-drawn lower part, in which a shoulder that runs around internally is provided, a cover part resting on said shoulder. The cover part is securely held on this shoulder by a raised and flanged rim of the lower part.

Since the cover part and lower part are manufactured from electrically conductive material, an insulating film is also provided therebetween, which film extends parallel to the cover part and is raised upwardly at the side, such that the flanged rim presses onto the cover part with the insulating film arranged between.

The temperature-dependent switching mechanism here comprises a spring snap-acting disk, which carries the movable contact part, and also a bimetal disk put on the movable contact part. The spring snap-acting disk carries what is known as a movable contact part, which is pressed by the spring disk against a stationary contact part inwardly on the cover part.

The spring snap-acting disk is supported by means of its rim in the lower part of the housing, such that the electric current flows from the lower part, through the spring snap-acting disk and the movable contact part, into the stationary contact and from there into the cover part.

A contact face arranged centrally on the cover part serves as a first external connection terminal. A contact face provided on the flanged rim of the lower part serves as a second external connection terminal. Both external connection terminals are thus arranged here on the upper surface of the known switch. It is also possible however to arrange the second external connection terminal not on the rim, but laterally on the current-guiding housing.

On the other hand, it is known from DE 198 27 113 C2 to attach what is known as a contact bridge to the spring snap-acting disk, said contact bridge being pressed by the spring snap-acting disk against two stationary contacts provided on the cover part. The current then flows from one stationary contact, through the contact bridge, into the other stationary contact, such that the operating current does not flow through the spring snap-acting disk itself.

This construction is then selected in particular when very high currents have to be switched, which can no longer be guided without difficulty via the spring disk itself.

In both construction variants, a bimetal disk which is placed in the switching mechanism in a force-free state below its transition temperature is provided for the temperature-dependent switching function, wherein the bimetal disk is arranged geometrically between the contact part or the contact bridge and the spring snap-acting disk.

If the temperature of the bimetal disk now rises as a result of a temperature increase in the device to be protected beyond the transition temperature, the configuration of the bimetal disk thus changes and it presses via its rim against an abutment, which is generally provided on the cover part. In doing so, the bimetal disk presses via its central region against the spring snap-acting disk and thus lifts the movable contact part from the stationary contact or lifts the current transfer member from the two stationary contacts, such that the switch opens and the device to be protected is switched off and cannot heat up further.

With these constructions, the bimetal disk is mounted mechanically in a force-free manner when being below its transition temperature, wherein the bimetal disk also is not used in any case to guide the current.

Here, it is advantageous that the bimetal disks have a long mechanical service life, and that the switching point, that is to say the transition temperature of the bimetal disk, also does not change after many switching operations.

If fewer demands on the mechanical reliability or the stability of the transition temperature can be tolerated, the bimetal disk may also take on the function of the spring snap-acting disk, such that the switching mechanism comprises only one bimetal disk, which then carries the movable contact part or the current transfer member and also guides the current in the closed state of the switch.

In addition, it is known to provide switches of this type with a parallel resistor, which is connected in parallel to the external connection terminals. This parallel resistor, when the switch is open, takes on some of the operating current and holds the switch at a temperature above the transition temperature, such that the switch does not automatically close again after cooling. Switches of this type are called self-holding switches.

It is further known to equip switches of this type with a series resistor, through which the operating current flowing through the switch flows. A resistive heat, which is proportional to the square of flowing current, is thus produced in the series resistor. If the amperage exceeds an admissible measure, the heat of the series resistor causes the switching mechanism to be opened.

A device to be protected is thus then already switched off from its supply circuit when an excessively high current flow is present that has not yet even caused the device to be excessively heated.

All of these different construction variants can be implemented with the switch according to the invention; in particular the bimetal disk can take on the function of the spring snap-acting disk.

Instead of a generally round bimetal disk, a bimetal spring fixed at one end may also be used, which bimetal spring carries a movable contact part or a contact bridge.

A temperature-dependent switch constructed in a manner comparable to that from DE 103 01 803 A1, mentioned in the introduction, is known from DE 195 17 310 A1, in which the cover part is manufactured from a positive temperature coefficient resistor material however and rests, without intermediate positioning of an insulating film, on a shoulder of the lower part, said shoulder running around internally, the cover part being pressed onto said shoulder by the flanged rim of the lower part.

An externally arranged head of a rivet sitting centrally in the cover part, the inwardly arranged head of said rivet serving as a fixed counter contact, serves as a first external connection terminal. Here, a contact face provided on the flanged rim of the lower part also serves as a second external connection terminal.

The positive temperature coefficient resistor cover is thus electrically connected in parallel to the two external connection terminals such that it provides the switch with a self-holding function.

In the case of the temperature-dependent switch with contact bridge known from above-mentioned DE 198 27 113 C2, the cover part is likewise manufactured from positive temperature coefficient resistor material, such that it likewise has a self-holding function. Here, two rivets are arranged on the cover part, the externally arranged heads of said rivets forming the two external connection terminals, and the internally arranged heads of said rivets cooperating as stationary contacts with the contact bridge.

With the known switches, the external connection terminals and the electrically conductive parts of the housing still have to be electrically insulated once connection lines have been soldered.

As insulation and pressure protection, the known switches are therefore often inserted into surrounding housings or protective caps, which provide mechanical and/or electrical protection and are often intended to protect the housing simultaneously against the infiltration of contaminations. Examples of this can be found for example in DE 91 02 841 U1, DE 92 14 543 U1, DE 37 33 693 A1 and DE 197 54 158.

On the other hand, it is known to therefore fit connection terminal caps onto the switches from above, that is to say from the connection terminal side, in order to ensure defined external connection and sealing of the housing. Examples of this can be found for example in DE 10 2005 001 371 B4 or DE 10 2009 030 353 B3.

It is also known from DE 41 43 671 A1 to insert mold the external connection terminals with a one-component thermosetting plastic. It is known from DE 10 2009 039 948 to cast the connection lugs with an epoxy resin.

An insulating cap for a temperature-dependent switch is known from DE 24 42 397 A1 and is formed as a cup-like surrounding housing and is slid with a matching fit from beneath onto the housing of the temperature-dependent switch, such that stranded wires soldered to the top of the switch housing are lead out upwardly from the cap. The opening in the cap is then closed by a cast resin cover. The cap consists of plastic and is used to electrically insulate the switch, of which the lower part consists of metal.

The use of surrounding housings or connection terminal caps is often found to be too complex in terms of design and unsatisfactory in respect of the thermal connection to the device to be protected.

A temperature-dependent switch having a bimetal disk, an insulator body and also external connection points and a housing, into which the bimetal disk and the insulator body are inserted, is known from DE 10 2011 016 896 B3. The housing can be produced from ferromagnetic steel in order to mechanically shield the switch mechanism.

A temperature-dependent switch having a fusible material which melts at a predetermined temperature and thus interrupts an electrical discharge path is known from U.S. Pat. No. 4,503,414 A. This fusible connection is arranged together with spacers in a shielding cup.

Although the switches described in this respect have proven their worth in everyday use and have many advantages in terms of functionality, there are currently increasing reports concerning problems regarding function, specifically in the case of loosely placed bimetal disks, and concerning undesirable arcs when opening the switches. These effects indicate problems with the electromagnetic shielding.

Corresponding tests carried out by the company of the applicant can thus prove that the effects are due to changes in the electromagnetic properties of the protected devices, which nowadays deviate from the conditions for which existing switches were originally designed.

The electromagnetic environment to which the switches are exposed during use appears to have changed in particular by modified compositions of the feed lines, windings, winding sheet metals, etc.

### SUMMARY OF THE INVENTION

In view of the above, one object underlying the present invention is to overcome or at least mitigate the above-mentioned problems in the known switch in a constructionally simple and economical manner.

This and other objects are achieved in accordance with the invention with the switch mentioned in the introduction in that said switch comprises a shielding cup made of an electrically conductive, metal material, into which the housing is inserted with its bottom side first.

Due to the additional shielding cup, which is merely fitted from below onto a switch of any design, considerably improved protection, even of existing switches, against electromagnetic fields is ensured in a constructionally simple and economical manner in accordance with the finding by the inventor.

Specifically, in accordance with the finding by the inventor, neither the conventional housing, generally manufactured from brass, has to be replaced by a housing providing an improved shielding effect, for example made of steel, nor a shielding housing fully surrounding the switch has to be provided, in order to protect an existing switch so reliably against the effects of electromagnetic fields that it can still be installed in the windings of motors or transformers, in which the electromagnetic ambient conditions have changed.

Even if the cover part of the housing consists of a positive temperature coefficient resistor material, no additional metal cover is necessary with the conventional dimensions of temperature-dependent switches, but instead the shielding cup is surprisingly sufficient as additional protection, although it does not cover the upper surface of the switch.

The inventor therefore has not followed the path of modifying the housing itself or inserting the switch into a shielding housing surrounding it from all sides.

Rather, the inventor of the present application has recognized that the effect of electromagnetic fields is fully prevented or at least reduced by a shielding cup fitted from beneath onto the housing.

Here, the shielding cup can be held mechanically on the housing, for example by crimping, clamping or flanging a raised rim of the shielding cup toward the upper surface of the switch inserted into the shielding cup. The shielding cup may alternatively or additionally also be connected by suitable resins or silicone to the upper surface of the switch.

According to one object, existing temperature-dependent switches can still be used and do not have to be redeveloped or redesigned. It is merely necessary to insert the known switch into the shielding cup provided in accordance with the invention. The shielding cup enlarges the geometric dimensions of the switch only slightly, such that it can also still be installed with the fitted shielding cup, as it can without the shielding cup.

In accordance with the invention, a shielding cup is consequently understood to mean an upwardly open outer cup, which, due to the physical properties of the material from which it is manufactured, shields the temperature-dependent switch received therein against electromagnetic fields. In particular, possible materials include electrically conductive metals and metal alloys.

According to another object, the shielding cup is manufactured from steel.

Here, in particular hot-rolled or cold-rolled deep-drawn steels provided without a coating or with a surface finish can be used as steels. The shielding cups are formed in particular from light gage sheet metals like deep drawn steels of DC grade.

The electrically conductive lower part of the housing of existing temperature-dependent switches is generally manufactured from brass, because brass is a material which can be easily processed due to its mechanical properties. These lower parts are sophisticated in terms of construction, they have shoulders, etc., and have to be manufactured in an extremely dimensionally accurate manner so that the switching function of the temperature-dependent switching mechanism is guaranteed.

In addition, the lower parts are responsible for the thermal connection to the device to be protected, which is why brass is preferred due to its good electrical and therefore also thermal conductivity.

It must also be taken into account that temperature-dependent switches have very small dimensions: the lower parts of the housing for example have a diameter from 8 to 10 mm and an overall height from 4 to 6 mm. Lower parts that are so small can be produced from steel, a material which conveys a very good electromagnetic shielding effect, only with much greater effort and therefore considerably higher costs compared to brass.

Although, for reasons of stability and due to the good electromagnetic shielding, switches with a steel housing also have advantages, they have the disadvantage, which is not to be underestimated, of high manufacturing costs, in particular when a high level of dimensional accuracy is still required with small dimensions.

By contrast, a shielding cup made of steel is constructed very simply: it preferably consists of a peripheral wall, which at the top delimits an insertion opening and at the bottom is terminated by a base. This simple structure can also be produced very economically from steel. In addition, in accordance with the finding by the inventor, the thicknesses of the peripheral wall and base can be kept very low, without impairing the shielding effect.

The thicknesses of the wall and base lie here in the range from 0.1 to 0.3 mm. Walls and bases that are so thin additionally ensure good thermal connection between the switch equipped with the shielding cup and the device to be protected.

Although an additional shielding cup made of steel is used in accordance with the invention, the costs for a switch equipped in this way are increased only insignificantly compared to the costs for the switch alone and are still lower than if the switch were to have a steel housing. In addition, no new switches have to be developed, tested and approved, and instead the existing switches can continue to be used.

The shielding cup made of steel protects the switch received therein, not only against electromagnetic fields, but it also provides mechanical protection, which the housing made of brass cannot provide.

Of course, the advantages of the shielding cup made of steel are also implemented with temperature-dependent switches of which the housings consist of a material other than brass, for example are manufactured from an insulating material or a sheet metal. Here, the pressure stability conveyed by the shielding cup has a particularly advantageous effect.

A temperature-dependent switch equipped in accordance with the invention with a shielding cup made of steel thus combines the advantages of the conventional housing to be produced economically and in a dimensionally accurate manner and the advantages of the steel housing, without resulting in the high costs associated with a steel housing.

According to a still further object, the shielding cup has an insertion depth which corresponds at least to the height of the housing between upper surface and bottom side, and is preferably at least 10% greater than this height.

Here, it is advantageous that the mechanical protection is effective not only against stresses from the side, but also against the effects of force from the upper surface or the bottom side. The overlap of the shielding cup thus provides improved mechanical protection. The shielding effect is also further improved by this measure.

According to another object, the shielding cup comprises a peripheral wall, which at the top delimits an insertion opening and at the bottom is terminated by a base, wherein the peripheral wall is preferably be bent over at its upper rim toward the upper surface of the housing.

Here, it is advantageous that the housing is held mechanically in the shielding cup by the bent-over rim, wherein the rim additionally provides mechanical protection of the cover part, which is particularly advantageous when the cover part is manufactured from insulating material or positive temperature coefficient resistor material.

According to a further object, the two external connection terminals are provided with connection lines, which lead out from the shielding cup at the top, wherein contact angles are preferably fastened via their short branches to the external connection terminals and the connection lines are fastened to the long branches of said contact angles. Furthermore, the long branches are preferably bent over toward the short branches.

These measures are advantageous from a constructional point of view since they enable simple installation of the housing in the shielding cup. Once the contact angles have been fastened to the connection terminal faces with long branches still upright, and once the connection lines have been fastened to the long branches, the housing thus assembled with connection lines and in which the temperature-dependent switching mechanism is of course already installed, is inserted from above into the shielding cup.

Because the connection lines still point vertically upwardly, the upper rim of the peripheral wall of the shielding cup can easily be bent inwardly in order to fix the housing mechanically. Only now are the long branches bent over toward the short branches, such that the connection lines lead away laterally from the switch, as is necessary for most applications.

According to one object, an electrically insulating material, preferably a silicone adhesive, one-component thermosetting plastic or a resin, in particular a composition containing an epoxy resin is applied to the upper surface, wherein the electrically insulating material covers at least the two external connection terminals and connects the shielding cup to the housing.

With this measure, it is advantageous that the shielding cup is not held purely mechanically or exclusively purely mechanically on the housing, but also/only in an integrally bonded manner. It is fixed to the housing automatically so to speak when the electrically insulating material is cured. The electrically insulating material, which is preferably a silicone adhesive, one-component thermosetting plastic or a casting resin, such as an epoxy resin, here covers at least the external connection terminals of the switch and also the stripped ends of the connection lines, which may possibly still be free.

The silicone adhesive or the resin further provides tension relief for the connection lines soldered to the external connection terminals or the branches of the contact angles, although a silicone adhesive does not provide the degree of stability provided by an epoxy resin. The electrically insulating material, however, provides further improved mechanical stability and pressure compatibility of the new switch and also improved electrical and mechanical protection of the cover part. The switch may consequently then also be wound into a winding of a coil when the cover part consists of a positive temperature coefficient resistor material.

The switch provided with the shielding cup may then subsequently still be introduced into a cap made of a heat shrink tube material in order to externally insulate the switch as a whole, for example as is known from DE 19 05 153, the content of which is hereby incorporated into the disclosure of the present application.

On this basis, the present invention also relates to a shielding cup for the new switch, wherein the shielding cup is provided with a peripheral wall, which at the top delimits an insertion opening and at the bottom is terminated by a base, wherein the shielding cup consists of an electrically conductive, metal material, preferably made of steel.

The new shielding cup has the features described above in conjunction with the new switch, wherein it can be supplied via third parties as a separately marketable part to a manufacturer of the temperature-dependent switches.

On the whole, the present invention further relates to a method for the final assembly of a temperature-dependent switch, comprising the following steps:
a) providing a temperature-dependent switch comprising a housing, which housing has a cover part and a lower part, and a temperature-dependent switching mechanism, which switching mechanism is arranged in the housing and which, depending on its temperature, produces or opens an electrically conductive connection between two external connection terminals provided on the switch,
b) connecting each a connection line to each one of the external connection terminals,
c) inserting the switch with the bottom side first into the new shielding cup, such that the connection lines lead out upwardly from the shielding cup,
d) applying an electrically insulating material to the upper surface of the housing, such that the electrically insulating material covers at least the external connection terminals provided on the upper surface, and
e) allowing the electrically insulating material to cure.

By means of the new method, pre-assembled switches, in which the switching mechanism has been installed in the housing, can be provided at any time with connection lines and then equipped with a shielding cup, such that they can then be wound into windings of transformers, for example.

Due to the electrically insulating material on the upper surface of the housing, oils or outgassing liquids used during this winding process cannot defuse or creep into the interior of the switch, and therefore the switch is not only mechanically stable, but is also superbly sealed with respect to the surrounding environment.

The new method and the new shielding cup can be used with switches of any construction, wherein changes to the switches themselves are not necessary.

In the embodiments below, three switch types are presented by way of example, which each comprise a cup-like lower part with a wall, of which the rim is flanged inwardly in order to fix the cover part to a shoulder of the lower part.

In the cover part, at least one external connection terminal for a connection line is provided, wherein the other external connection terminal is provided either also on the cover part (when the temperature-dependent switching mechanism carries a contact plate), or the rim itself or the base or a wall of the electrically conductive lower part can be formed in part as a further external connection terminal.

Switches of this type are sold in multiples by the company of the applicant, and may be equipped with a cover part made of positive temperature coefficient resistor material or with a cover part made of insulator material or with a cover part made of electrically conductive material, wherein appropriate insulating measures are provided in each case so that no short circuit is produced between electrically conductive parts, which would impair the functionality of the switch.

In accordance with one object of the invention, a shielding cup adapted in terms of its geometry to the respective switch types is now fitted onto these existing switches as required and protects the received switch effectively against the effect of electromagnetic fields.

According to one object, in step b), two contact angles are each fastened via their short branch to one of the two external connection terminals and if one of the two connection lines is fastened to the respective long branches of said contact angles.

According to a further object, in step c), the peripheral wall is bent over at its upper rim toward the upper surface of the housing.

In step c), the long branches are further preferably bent over toward the short branches.

The advantages already mentioned above are associated with these measures. The new switch can thus be protected in a constructionally simple and economical manner against the effect of electromagnetic fields.

Further features and advantages will emerge from the description and the accompanying drawings.

It goes without saying that the features mentioned above and the features yet to be explained below can be used not only in each of the specified combinations, but also in other combinations or in isolation, without departing from the scope of the present invention.

### BRIEF DESCRIPTION OF THE DRAWINGS

Embodiments of the invention are illustrated in the drawings and will be explained in greater detail in the following description. In the drawings:

FIG. 1 shows a side view of a schematic sectional illustration of a temperature-dependent switch in a first embodiment;

FIG. 2 in an illustration similar to FIG. 1, shows a further embodiment of a temperature-dependent switch, which has a cover part made of positive temperature coefficient resistor material;

FIG. 3 shows a schematic plan view of the switch from FIG. 1 or FIG. 2, with soldered connection lines;

FIG. 4 in an illustration similar to FIG. 1, shows a further embodiment of a temperature-dependent switch, which has a contact bridge and a cover part made of positive temperature coefficient resistor material;

FIG. 5 shows a schematic plan view of the switch from FIG. 4, with soldered connection lines;

FIG. 6 in a schematic side view, shows the switch from FIG. 4, in which connection lines are soldered to contact angles arranged on the upper surface, wherein a shielding cup is shown schematically and in sectional side view below the switch,

FIG. 7 shows the switch from FIG. 6 inserted into the shielding cup in a view rotated by 90° compared to FIG. 6;

FIG. 8 shows a plan view of the switch from FIG. 3, 5 or 7, wherein epoxy resin covers the upper surface of the switch; and

FIG. 9 shows a side view of the switch from FIG. 8.

### DESCRIPTION OF PREFERRED EMBODIMENTS

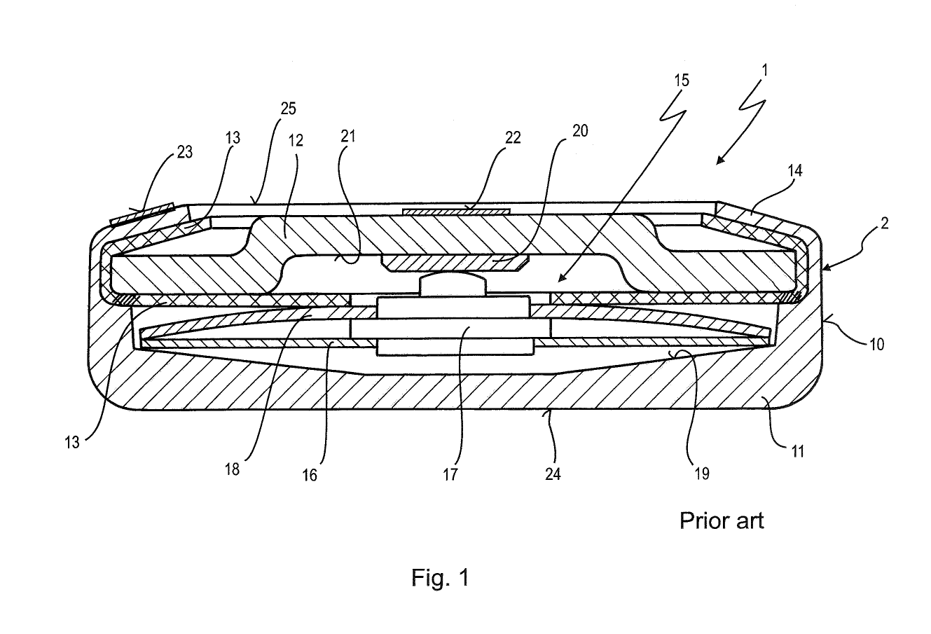

In FIG. 1, a temperature-dependent switch 1 is shown schematically, not to scale, and in lateral section, which switch has a housing 2, which has a wall 10, which here is a cylindrically peripheral wall 10, formed on an electrically conductive cup-like lower part 11, which is closed by a plate-like, electrically conductive cover part 12. The cover part 12 is held on the housing lower part 11 by a flanged rim 14 of the wall 10 with intermediate positioning of an insulating film 13.

In the housing of the switch 1 formed by the lower part 11 and the cover part 12, a temperature-dependent switching mechanism 15 is arranged, which switching mechanism comprises a spring snap-acting disk 16, which centrally carries a movable contact part 17, on which a freely placed bimetal disk 18 sits.

Within the scope of the present invention, a bimetal disk is understood to mean a multi-layered, active, sheet-shaped component part formed from two, three or four inseparably interconnected components having different coefficients of expansion. The individual layers formed from metals or metal alloys are integrally bonded or connected in a form-locked manner and for example are connected by rolling.

The spring snap-acting disk 16 is supported on a base 19 internally on the lower part 11, whereas the movable contact part 17 is in abutment with a stationary contact part 20, which is provided on an inner face 21 of the cover part 12.

In the case of the switch from FIG. 1, a central region of the cover part 12 on the one hand and a region on the flange rim 14 on the other hand serve as external connection terminals 22 and 23.

The lower part 11 is provided with a flat outer bottom side 24, via which the switch 1 is coupled thermally to a device to be protected.

The two external connection terminals 22, 23 are therefore arranged beside one another on an upper outer surface 25 of the housing.

The temperature-dependent switching mechanism 15 in the low-temperature position shown in FIG. 1 thus produces an electrically conductive connection between the two external connection terminals 22, 23, wherein the operating current flows via the stationary contact part 20, the movable contact part 17, the spring snap-acting disk 16, and the lower part 11.

If, in the case of the switch 1 from FIG. 1, the temperature of the bimetal disk 18 rises above its response temperature via the thermal contact between the bottom side 24 and the device to be protected, it thus snaps over from the convex position shown in FIG. 1 into its concave position, in which it lifts the movable contact part 17 from the stationary contact part 20 against the force of the spring disk 16 and therefore opens the circuit.

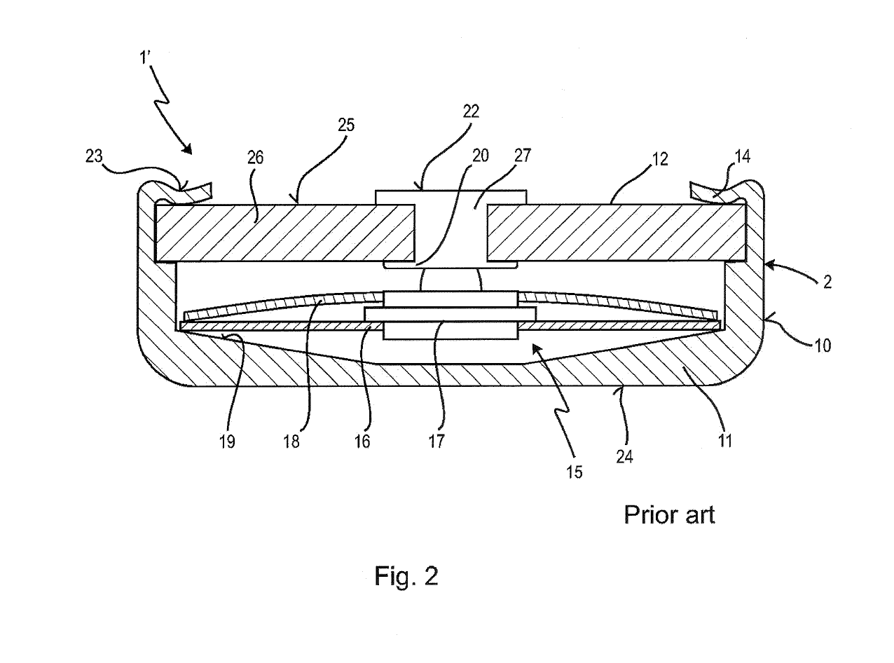

FIG. 2 shows a temperature-dependent switch 1′ which is constructed similarly to the switch 1 from FIG. 1. Like constructional features are provided with the same reference signs as in FIG. 1.

In contrast to the switch 1, in the case of the switch 1′, the cover part 12 is not manufactured from electrically conductive material, but from a positive temperature coefficient resistor material 26, which acts as a self-holding resistor, such that the switch 1′ is held in the open state until the supply voltage is switched off.

Within the scope of the present invention, a “positive temperature coefficient resistor material” is understood to mean a current-carrying ceramic material which has a positive temperature coefficient, such that its electrical resistance increases with rising temperature. The course of the electrical resistance value over temperature is non-linear here.

Positive temperature coefficient resistors of this type are also referred to as PTC resistors. They are manufactured for example from semi-conductive, polycrystalline ceramics, such as BaTiO3.

The stationary contact part 20 is formed by an inwardly arranged head of a rivet 27, which penetrates the cover part and with its externally arranged head forms the external connection terminal 22.

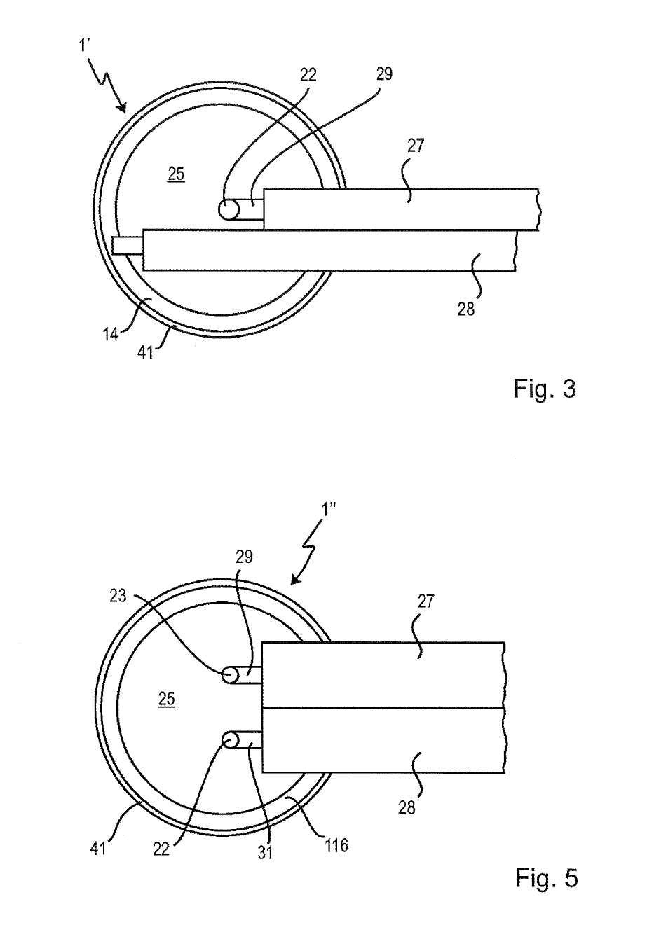

FIG. 3 shows a schematic plan view of the switches 1 and 1′, which do not differ significantly in this view.

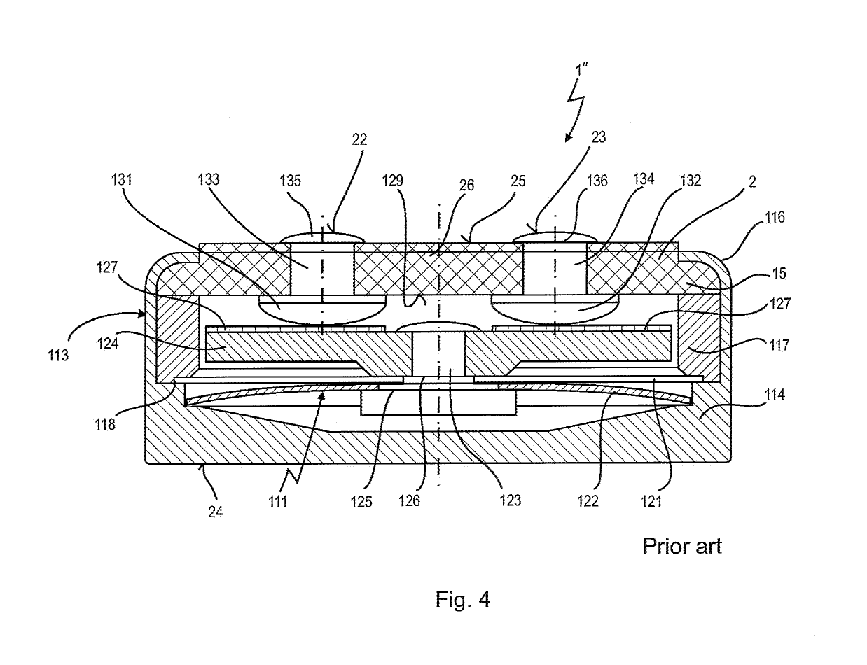

In FIG. 3, each a connection line 27, 28 is soldered via its respective stripped end 29, 31 to the external connection terminals 22 and 23 respectively.

Whereas the switches 1 and 1′ from FIGS. 1 and 2 are provided with a switching mechanism 15, in which the current flows through the spring snap-acting disk 16, FIG. 4 shows a switch 1″, in which the current is guided through a contact plate, such that this switch 1″ can switch higher currents.

In FIG. 4, the temperature-dependent switch 1″ comprises a temperature-dependent switching mechanism 111, which is accommodated in the housing 2, which in turn comprises the bottom side 24 and the upper surface 25.

The housing 2 comprises a lower part 114 having a peripheral wall 113, here a cylindrical wall, and also a cover part 115, which closes said lower part, is made of insulating material, and is held on the lower part 114 by a flanged rim 116 of the wall 113 thereof. A ring 117 is arranged between the lower part 114 and the cover part 115 and is supported on a step 118 of the lower part 114, where it guides a spring snap-acting disk 121 of the switching mechanism 111 at its rim.

The switching mechanism 111, in addition to the spring snap-acting disk 121, also comprises a bimetal disk 122, which together with the spring snap-acting disk 121 is penetrated centrally by a pin-like rivet 123, by means of which said disks are mechanically connected to a current transfer member in the form of a contact plate 124. The rivet 123 has a first step 125, on which the bimetal disk 122 sits with radial and axial play, wherein a second step 126 is provided, on which the spring snap-acting disk 121 sits, likewise with radial and axial play.

The bimetal disk 122 is supported inwardly in the lower part 114 via its peripheral rim.

The contact plate 124 already mentioned, in the direction of the cover part 115, has two electrically interconnected, large-area contact faces 127, which cooperate with two stationary contacts 131, 132 arranged on the inner surface 129 of the cover part 115, which are inner heads of contact rivets 133, 134, which pass through the cover part 115 and, with their outer heads 135, 136 on the upper surface 25 of the cover part 115 and therefore of the housing 2, serve as external connection terminals 22 and 23.

In the switching position shown in FIG. 4, spring snap-acting disk 121 and bimetal disk 122 do press the contact plate 124 against the stationary contacts 131 and 132, which are therefore interconnected via the contact faces 127; the switch 1″ is thus closed.

If the temperature of the bimetal disk 122 rises above its response temperature, it thus snaps over from the shown convex form into a concave form and in doing so is supported via its rim in the region of the ring 117 and draws the contact plate 124 away from the stationary contacts 131, 132, against the force of the spring snap-acting disk 121; the switch 1″ is now open.

The switch described thus far is known from DE 198 27 113 C2, however the cover part 115 consists of insulating material. As with the switch known from DE 198 27 113 C2, the cover part 115 may alternatively also be manufactured from a positive temperature coefficient material 26, that is to say it may be a PTC resistor, which is electrically connected between the stationary contacts 131, 132. The cover part 115 then acts as a self-holding resistor.

FIG. 5 shows a plan view of the switch 1″ in an illustration similar to FIG. 3. Here too, each a connection line 27, 28 is soldered via its respective stripped end 29, 31 to one of the external connection terminals 22 and 23, respectively.

The switches 1, 1′ and 1′″ are inserted into a shielding cup 41, indicated schematically, which electromagnetically shields the switches 1, 1′ and 1″ in a manner yet to be described and consists of an electrically conductive, metal material and is preferably manufactured as a turned part made of steel.

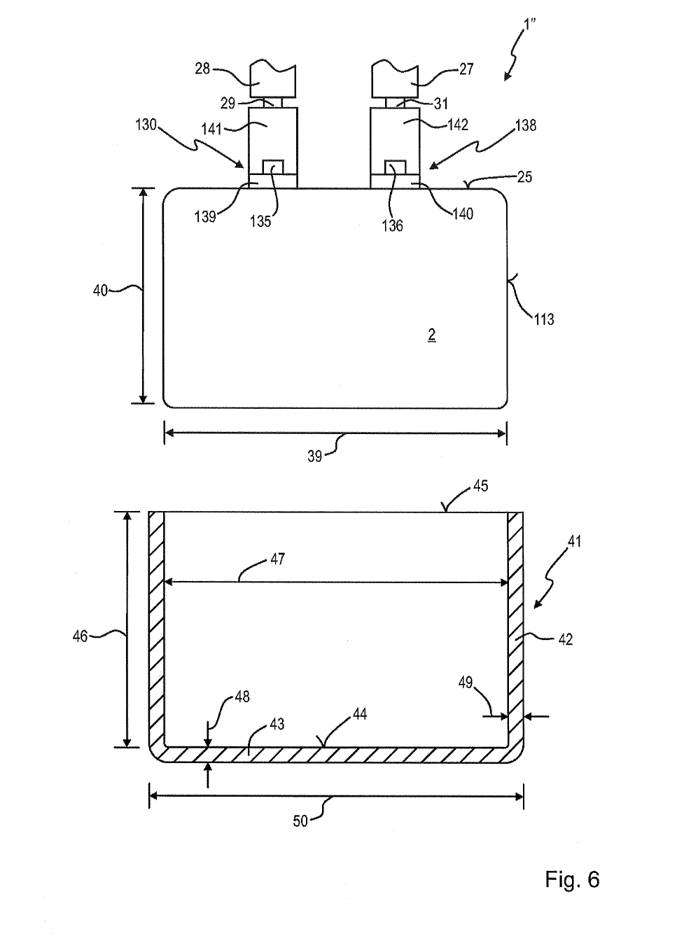

The top of FIG. 6 shows a schematic side view of the switch 1″, wherein contact angles 137 and 138 are fastened here via their short branches 139, 140 to the outer heads 135, 136 of the contact rivets 133, 134, that is to say to the connection terminal faces 22, 23, wherein each a connection line 27, 28 is soldered via its respective stripped end 29 and 31 to the upright, long branches 141, 142 of said contact angles. The housing 2 has an outer diameter denoted by 39 and a height denoted by 40 between the bottom side 24 and upper surface 25.

The shielding cup 41 known from FIGS. 3 and 5 is shown in FIG. 6 beneath the switch 1″ in sectional side view and has a peripheral wall 42, here a cylindrical wall, and is terminated downwardly by a flat base 43 having an internal support surface 44. Opposite the base 43, the shielding cup 41 has an insertion opening 45, through which the switch 1″ is inserted with its bottom side 25 first, which thus comes to rest on the support surface 44.

Between the support surface 44 and insertion opening 45, the shielding cup 41 has an insertion depth denoted by 46, which is slightly greater, at least 10% greater, than the height 40 of the housing 2. The shielding cup 41 has an inner diameter 47 which is slightly greater than the outer diameter 39 of the housing 2, such that the housing 2 can be inserted into the shielding cup 41 and the wall 42 then bears tightly against the wall 113 of the housing 2.

The base 43 has a thickness denoted by 48, and the wall 42 has a thickness denoted by 49. Reference sign 50 denotes the outer diameter of the shielding cup 41.

The shielding cup 41 is manufactured from an electrically conductive, metal material, such as steel, for example from a deep-drawn sheet metal of DC grade. The insertion depth 46 for example is 5 mm, the outer diameter 50 for example is 10 mm, and the thicknesses 48 and 49 for example are each approximately 0.5 mm. The height 40 is then 4 mm for example, such that the wall 43 with the housing 2 inserted into the shielding cup 41 protrudes approximately 1 mm beyond the upper surface 24.

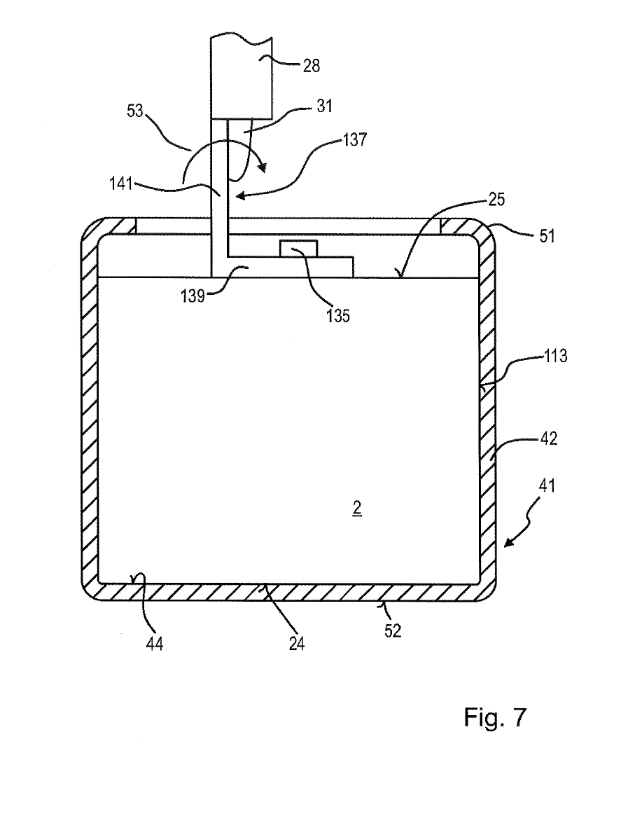

In FIG. 7, the switch 1″ is shown in this state inserted into the shielding cup 41, wherein the shielding cup 41 is illustrated in section. The switch 1″ in FIG. 7 is rotated by 90° in an anti-clockwise direction compared to the illustration in FIG. 6, such that the contact angle 137 can be seen from the side. The connection lines 28, 27 soldered to the long branches 141, 142 protrude vertically upwardly from the shielding cup 41.

In the next manufacturing step, the peripheral wall 42 is bent over at its upper rim 51, which is easily done because the connection lines point upwardly.

The housing 2 now rests with the bottom side 24 on the support surface 44 and is held securely in the shielding cup 41 via the upper rim 51 of the wall 42 to be bent over slightly inwardly after insertion of the housing, that is to say toward the upper surface 25 of the housing 2.

The shielding cup 41 via its outer bottom side 52 produces the thermal contact to the device to be protected. Because the housing 2 is in thermal contact via its bottom side 24 with the support surface 44 and is in thermal contact via its wall 113 with the wall 42, it is thermally connected to the device to be protected. The quality of the thermal connection is determined by the strength of the mechanical abutment between the housing 2 and shielding cup 4 and also by the material from which the shielding cup is manufactured, which is also simultaneously a good thermal conductor due to its electrical conductivity.

Because the rim 51 of the peripheral wall 42 projects above the upper surface 25, the shielding cup 41 shields the housing 2 not only with respect to electromagnetic fields, but also protects mechanically against compressive stresses from above and from the side. This is particularly advantageous with switches of which the cover part 12 consists of positive temperature coefficient material or insulating material.

In the next manufacturing step, the two long branches 141, 142 are to be bent along the arrow 53 toward the short branches 139, 140, such that the long branches 141, 142 extend approximately parallel to the upper surface 245, and the connection lines 28, 27 lead out upwardly and laterally from the shielding cup 41.

With the final assembly of the new switch, pre-assembled switches 1, 1′ and 1″ are thus inserted as required from above into a shielding cup 41 and are held therein in a form-locked and/or force-locked manner.

If, with the switches 1 and 1′ from FIGS. 3 and 5 respectively, the rim 51 is bent over inwardly, they are specifically also held securely in the shielding cup 41, beyond which their connection lines 28, 27 protrude laterally.

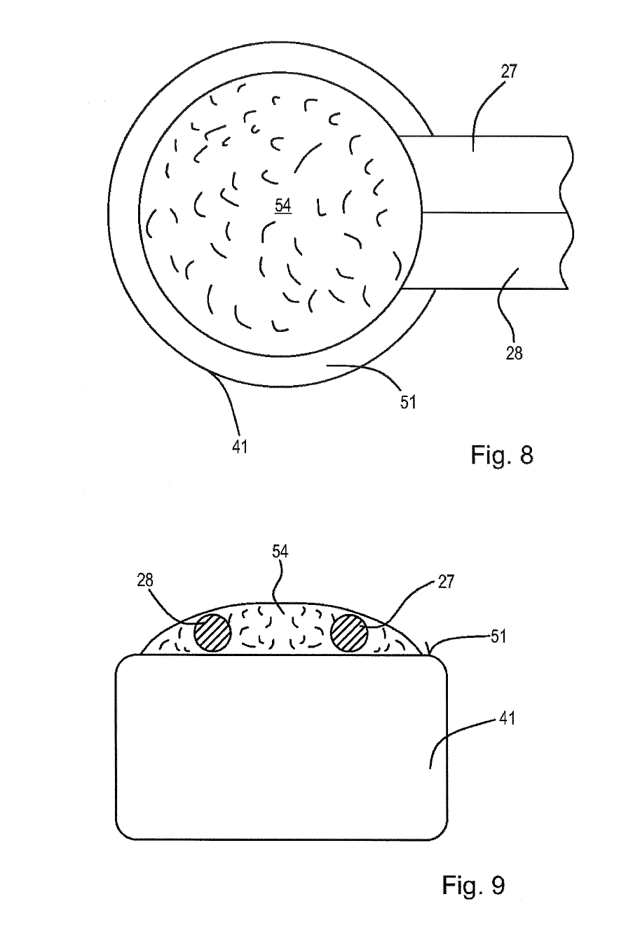

For all embodiments according to FIGS. 3, 5 and 7 (once the long branches 141, 142 have been bent over), the insertion opening 45 surrounded by the rim 51 is closed by a cast resin cover or another suitable electrically insulating material. To this end, an electrically insulating material 54 is placed within the rim 51 on the upper surface 25 and covers the entire upper surface 25 and therefore the stripped ends 29, 31 and the portions of the connection lines 27, 28 running over the upper surface 25, as is shown in plan view in FIG. 8.

Once the electrically insulating material 54 has cured, this not only protects the connection terminal faces 22, 23, the stripped ends 29, 31 and the cover part 12 or 115 against mechanical damage and unwanted electrical contact, but protects the switch as a whole against the infiltration of contaminations. Furthermore, the cured electrically insulating material 54 holds the housing 2 securely and immovably in the shielding cup 41.

In FIG. 9, the switch from FIG. 8 is shown in side view with cut connection lines 27, 28. It can be seen in FIG. 9 that the electrically insulating material 54 projects upwardly above the shielding cup 41 and is domed, such that the upper surface of the housing 2 is mechanically and electrically protected.

The switches 1, 1′, 1″ are protected much better by the shielding cup 41 made of steel with respect to the effect of electromagnetic fields than if the switch in question were used without a shielding cup 41, where the influences of the electromagnetic fields on the bimetal disks and on arcs produced when the switch is opened may lead to malfunctions or to a reduction of the service life.

What is claimed is:

1. A temperature-dependent switch comprising a housing, a temperature-depending switching mechanism, and a shielding cup,
said housing comprising an outer upper surface, a cover part and a lower part, said lower part comprising a peripheral wall and an outer bottom side, two external connection terminals being provided on said outer upper surface,
said temperature-dependent switching mechanism being arranged in said housing and, depending on its temperature, producing or opening an electrically conductive connection between said two external connection terminals,
said shielding cup being made of an electrically conductive, metal material, and
said housing being inserted with its bottom side first into said shielding cup.

2. The switch of claim 1, wherein the shielding cup is manufactured from steel.

3. The switch of claim 1, wherein the shielding cup comprises a peripheral wall having a top, which peripheral wall at the top delimits an insertion opening for said housing and at the bottom is terminated by an inner base in abutment with said outer bottom side.

4. The switch of claim 1, wherein the shielding cup has an insertion depth between said top and said inner base, and said housing has a height between said outer upper surface and said outer bottom side, said insertion depth being at least equal to said height of said housing.

5. The switch of claim 4, wherein the insertion depth is at least 10% greater than the height.

6. The switch of claim 3, wherein the peripheral wall comprises an upper rim and is bent over at said upper rim toward said outer upper surface of the housing.

7. The switch of claim 4, wherein the peripheral wall comprises an upper rim and is bent over at said upper rim toward said outer upper surface of the housing.

8. The switch of claim 1, wherein each of said two external connection terminals is provided with a connection line, each connection line leading out from the shielding cup at its top.

9. The switch of claim 3, wherein each of said two external connection terminals is provided with a connection line, each connection line leading out from the shielding cup at its top.

10. The switch of claim 6, wherein each of said two external connection terminals is provided with a connection line, each connection line leading out from the shielding cup at its top.

11. The switch of claim 1, wherein two contact angles are provided, each contact angle having a short branch and a long branch, each short branch being fastened to one of said two external connection terminals, and a connection line being fastened to each long branch.

12. The switch of claim 11, wherein each long branch is bent over toward the short branch of the respective contact angle.

13. The switch of claim 1, wherein an electrically insulating material is applied to said outer upper surface and covers at least said two external connection terminals and connects the shielding cup to the housing.

14. The switch of claim 13, wherein the electrically insulating material is selected from the group consisting of a silicone adhesive, a one-component thermosetting plastic and a resin.

15. A method for assembling a temperature-dependent switch, comprising the following steps:
a) providing a temperature-dependent switch comprising a housing and a temperature-depending switching mechanism, said housing comprising an outer upper surface, a cover part and a lower part, said lower part comprising a peripheral wall and an outer bottom side, two external connection terminals being provided on said upper surface, said temperature-dependent switching mechanism being arranged in said housing and, depending on its temperature, producing or opening an electrically conductive connection between said two external connection terminals,
b) providing two connection lines, and connecting each one of the two connection lines to each one of the two external connection terminals;
c) providing a shielding cup that comprises a peripheral wall having a top, which peripheral wall at said top delimits an insertion opening and at the bottom is terminated by an inner base;
d) inserting the switch with the outer bottom side first through said insertion opening into said shielding cup, such that said two connection lines lead out upwardly from the shielding cup;
e) applying an electrically insulating material to the outer upper surface of the housing, such that the electrically insulating material covers at least said two external connection terminals provided on the outer upper surface; and
f) allowing the electrically insulating material to cure.

16. The method of claim 15, wherein, in step b), two contact angles are provided, each contact angle having a short branch and a long branch, each short branch being fastened to one of said two external connection terminals, and a connection line being fastened to each long branch.

17. The method of claim 15, wherein, in step d), the peripheral wall is being bent over at its upper rim toward the upper surface of the housing.

18. The method of claim 16, wherein characterized in that, in step d), the long branches are bent over toward the short branches.
